(19) United States
(12) Patent Application Publication
(10) Pub. No.: US 2026/0138931 A1
(43) Pub. Date: May 21, 2026

(54) CERAMIC MATRIX COMPONENT PROCESSING

(71) Applicant: General Electric Company, Evendale, OH (US)

(72) Inventors: Anant Achyut Setlur, Niskayuna, NY (US); Curtis Alan Johnson, Niskayuna, NY (US); Kaushik Vijaykumar, Saunderstown, RI (US)

(21) Appl. No.: 18/952,105

(22) Filed: Nov. 19, 2024

(51) Int. Cl. C04B 41/00; C04B 35/80; C04B 41/50; C04B 41/52; C04B 41/89

(52) U.S. Cl. CPC C04B 41/0072; C04B 35/80; C04B 41/5024; C04B 41/5096; C04B 41/52; C04B 41/89

(57) ABSTRACT

A method for processing a ceramic matrix composite (CMC) component with an environmental barrier coating (EBC) includes heat treating the CMC component, after heat treating the CMC component, heating an upper surface of the EBC of the CMC component to a first temperature and controlling a temperature of a lower surface of a substrate of the CMC component at a second temperature that is less than the first temperature to maintain a thermal gradient within the EBC within a specified range for a specified period of time, and after the specified period of time has elapsed, ceasing heating of the upper surface of the EBC and controlling of the temperature of the lower surface of the substrate.

### FIELD

The present disclosure relates to ceramic matric composite components and methods for processing ceramic matric composite components.

### BACKGROUND

The design of modern gas turbine engines is driven by the demand for higher turbine efficiency. Ceramic matrix composites (“CMCs”) are an attractive material for turbine applications, as CMCs have high temperature capability and are light weight. CMC components are often protected with an environmental barrier coating (“EBC”) in turbine engine environments to avoid oxidation and recession in the presence of high temperature air flow.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic view of an exemplary ceramic matrix composite component.

FIG. 2 is a block diagram of an exemplary method for processing the ceramic matrix composite component.

FIG. 3 is a diagram of stress in the exemplary ceramic matrix composite component over time.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

The phrases “from X to Y” and “between X and Y” each refers to a range of values inclusive of the endpoints (i.e., refers to a range of values that includes both X and Y).

As used herein, the terms “first,” “second,” “third,” and other ordinals are used to distinguish one component or feature from another and are not intended to signify location or importance of the individual components or features.

As used herein, ceramic-matrix-composite or “CMC” refers to a class of materials that include a reinforcing material (e.g., reinforcing fibers) surrounded by a ceramic matrix phase. Generally, the reinforcing fibers provide structural integrity to the ceramic matrix. Some examples of matrix materials of CMCs can include, but are not limited to, non-oxide silicon-based materials (e.g., silicon carbide, silicon nitride, silicon, or mixtures thereof), oxide ceramics (e.g.,, silicon oxycarbides, silicon oxynitrides, aluminum oxide (Al₂O₃), silicon dioxide (SiO₂), aluminosilicates, or mixtures thereof), or mixtures thereof. Optionally, ceramic particles (e.g., oxides of Si, Al, Zr, Y, and combinations thereof) and inorganic fillers (e.g., pyrophyllite, wollastonite, mica, talc, kyanite, and montmorillonite) may also be included within the CMC matrix.

Some examples of reinforcing fibers of CMCs can include, but are not limited to, non-oxide silicon-based materials (e.g., silicon carbide, silicon nitride, or mixtures thereof), non-oxide carbon-based materials (e.g., carbon), oxide ceramics (e.g., silicon oxycarbides, silicon oxynitrides, aluminum oxide (Al₂O₃), silicon dioxide (SiO₂), aluminosilicates such as mullite, or mixtures thereof), or mixtures thereof.

Generally, particular CMCs may be referred to as their combination of type of fiber/type of matrix. For example, C/SiC for carbon-fiber-reinforced silicon carbide; Si/SiC, SiC/SiC for silicon carbide-fiber-reinforced silicon carbide, SiC/SiN for silicon carbide fiber-reinforced silicon nitride; SiC/SiC—SiN for silicon carbide fiber-reinforced silicon carbide/silicon nitride matrix mixture, etc. In other examples, the CMCs may include a matrix and reinforcing fibers comprising oxide-based materials such as aluminum oxide (Al₂O₃), silicon dioxide (SiO₂), aluminosilicates, and mixtures thereof. Aluminosilicates can include crystalline materials such as mullite (3Al₂O₃·2SiO₂), as well as glassy aluminosilicates.

In certain embodiments, the reinforcing fibers may be bundled and/or coated prior to inclusion within the matrix. For example, bundles of the fibers may be formed as a reinforced tape, such as a unidirectional reinforced tape. A plurality of the tapes may be laid up together to form a preform component. The bundles of fibers may be impregnated with a slurry composition prior to forming the preform or after formation of the preform. The preform may then undergo thermal processing and subsequent chemical processing to arrive at a component formed of a CMC material having a desired chemical composition. For example, the preform may undergo a cure or burn-out to yield a high char residue in the preform, and subsequent melt-infiltration with silicon, or a cure or pyrolysis to yield a silicon carbide matrix in the preform, and subsequent chemical vapor infiltration with silicon carbide. Additional steps may be taken to improve densification of the preform, either before or after chemical vapor infiltration, by injecting it with a liquid resin or polymer followed by a thermal processing step to fill the voids with silicon carbide. CMC material as used herein may be formed using any known or hereinafter developed methods including but not limited to melt infiltration, chemical vapor infiltration, polymer impregnation pyrolysis (PIP), or any combination thereof.

Such materials, along with certain monolithic ceramics (i.e., ceramic materials without a reinforcing material), are particularly suitable for higher temperature applications. Additionally, these ceramic materials are lightweight compared to superalloys, yet can still provide strength and durability to the component made therefrom. Therefore, such materials are currently being considered for many gas turbine components used in higher temperature sections of gas turbine engines, such as airfoils (e.g., turbines, and vanes), combustors, shrouds and other like components, that would benefit from the lighter-weight and higher temperature capability these materials can offer.

Chemical elements are discussed in the present disclosure using their common chemical abbreviation, such as commonly found on a periodic table of elements. For example, hydrogen is represented by its common chemical abbreviation H; helium is represented by its common chemical abbreviation He; and so forth. As used herein, “RE” refers to a rare earth element or a mixture of rare earth elements. More specifically, the “RE” refers to the rare earth elements of scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), or mixtures thereof.

In the present disclosure, when a layer is being described as “on” or “over” another layer or substrate, it is to be understood that the layers can either be directly contacting each other or have another layer or feature between the layers, unless expressly stated to the contrary. Thus, these terms are simply describing the relative position of the layers to each other and do not necessarily mean “on top of” since the relative position above or below depends upon the orientation of the device to the viewer.

As used herein, environmental-barrier-coating or “EBC” refers to a coating system comprising one or more layers of ceramic materials, each of which provides specific or multi-functional protections to the underlying CMC. EBCs generally include a plurality of layers, such as rare earth silicate coatings (e.g., rare earth disilicates such as slurry or APS-deposited yttrium ytterbium disilicate (YbYDS)), mullite (e.g. with a nominal 3Al₂O₃-2SiO₂ composition), alkaline earth aluminosilicates (e.g., comprising barium-strontium-aluminum silicate (BSAS), such as having a range of BaO, SrO, Al₂O₃, and/or SiO₂ compositions), hermetic layers (e.g., a rare earth disilicate), and/or outer coatings (e.g., comprising a rare earth monosilicate, such as slurry or APS-deposited yttrium monosilicate (YMS)). One or more layers may be doped as desired, and the EBC may also be coated with an abradable coating.

As used herein, the term “barrier coating(s)” can refer to environmental barrier coatings. The barrier coatings herein may be suitable for application to “components” found in high temperature environments (e.g., operating temperatures of about 2500° C.), such as those present in gas turbine engines. Examples of such components can include, for example, combustor components, turbine blades, shrouds, nozzles, heat shields, and vanes.

As used herein, the term “barrier material” refers to compositions that are useful for forming a layer of a barrier coating on a component, such as a layer of an environmental barrier coating (“EBC”). Barrier materials that are particularly suitable for forming a layer of an EBC may be referred to as “EBC material.”

As used herein, “silica” refers to silicon oxide in the form of SiO₂. Conversely, “elemental silicon” refers to silicon without any alloying materials present, outside of incidental impurities. It is sometimes referred to in the art as “silicon metal.” Elemental silicon has a melting point of about 1414° C.

As used herein, the term “mullite” generally refers to a mineral containing alumina and silica. That is, mullite is a chemical compound of alumina and silica with an alumina (Al₂O₃) and silica (SiO₂) ratio of about 3 to 2 (e.g., within 10 mole % of 3 to 2 of alumina to silica). However, a ratio of about 2 to 1 has also been reported as mullite (e.g., within 10 mole % of 2 to 1 of alumina to silica).

A “thermal gradient” is a temperature distribution of the CMC component caused by a temperature difference between two portions of the CMC component, such as between portions of the EBC and/or between the EBC and the substrate.

The present disclosure is generally related to ceramic coatings for CMC components. Such coatings often need a specified thickness to provide protection from contaminants, but materials used in the coatings may undergo different thermal expansion than layers beneath the coatings. That is, a coefficient of thermal expansion (“CTE”) of the material of the coatings may differ from the CTE of the other layers, such as a bond coat or a substrate. As such, when a temperature of the CMC component changes, the CTE mismatch may cause the coating to expand or contract more than the other layers, causing the coating to separate from the underlying layers. In particular, following a heat treatment process for forming the coated CMC component, cracks may form between the coating and a bond coat, which may propagate from thermal stresses induced when the CMC component cools and separate the coating from the bond coat. When the CMC component is an aerospace component, such as a shroud or an airfoil, the desired thickness of the coating may lead to this separation.

To reduce or inhibit the coating from separating from other layers, following the heat treatment process, the coating surface may be heated to a specified temperature to cause a thermal gradient between the coating and the substrate. Applying the thermal gradient over a specified period of time relaxes residual thermal stresses primarily in the coating. As the coating cools, compressive residual stresses from CTE mismatch between differing layers are then decreased or reversed versus after the isothermal heat treatment, which reduces the tendency for edge crack propagation near the interface between the coating and the bond coat. The substrate may be heated to a second specified temperature to induce a specific thermal gradient. Maintaining the thermal gradient reduces the tendency for crack propagation, which reduces the likelihood of the coating separating from the bond coat, improving the structural integrity of the CMC component.

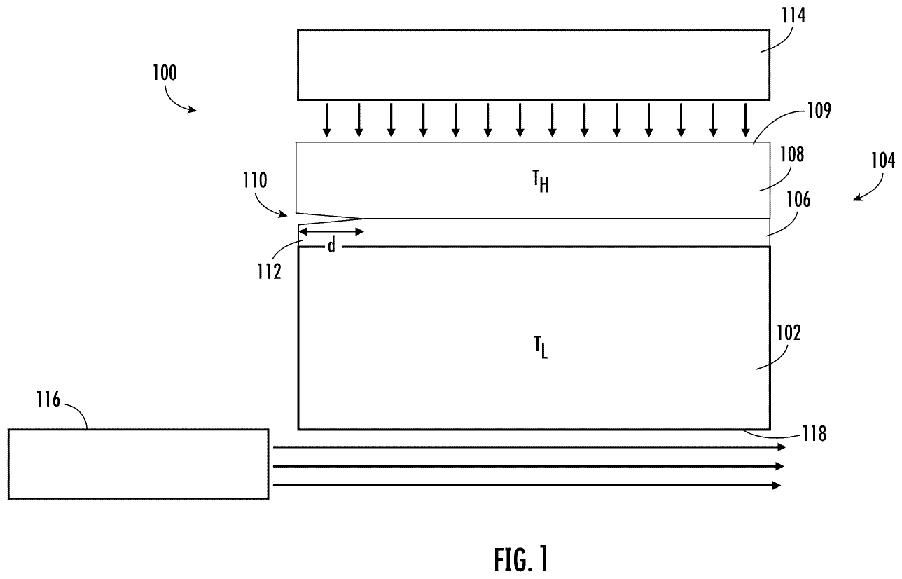

Referring now to the drawings, wherein identical numerals indicate the same elements throughout the figures, FIG. 1 is a side view of an exemplary coated component 100 is shown formed from a substrate 102 having a surface with a coating system 104 thereon. The substrate 102 may be any suitable material, for example, a CMC material as described above. The coating system 104 may be disposed along one or more portions of the substrate 102 or disposed substantially over the whole exterior of the substrate 102, such as on an upper surface of the substrate 102.

Generally, the coating system 104 includes a bond coat 106 on the surface of the substrate 102. In the embodiment shown, the bond coat 106 is directly on the surface without any deposited layer therebetween. Materials widely used for the bond coat 106 in EBC systems may include, but are not limited to, silicon, silica, silicates, silicides (e.g., a rare earth silicide such as molybdenum silicide or rhenium silicide, or mixtures thereof), mullite, or combinations thereof. That is, the bond coat 106 may be silicon-based.

An environmental barrier coating (EBC) 108 is formed on the bond coat 106. The EBC 108 may include any combination of one or more layers formed from materials selected from typical EBC layer chemistries, such as those described above. The EBC 108 is formed as a single layer in the embodiment shown, and it will be appreciated that the EBC 108 may include additional layers of material, such as hermetic layers that encase a silicon phase of the bond coat 106.

A crack 110 may form at an edge 112 of the component 100 between the bond coat 106 and the EBC 108. In this context, a “crack” is a separation between the bond coat 106 and the EBC 108 that starts at the edge 112 of the component 100 where the bond coat 106 and the EBC 108 meet. The crack 110 extends to a depth d, defined as the distance from the edge 112 at which the bond coat 106 and the EBC 108 begin to separate from each other. Following heat treatment of the component 100, compressive stresses may be induced in the EBC 108 that cause the crack 110 to propagate into the component 100, increasing the depth d until the EBC 108 separates from the bond coat 106 entirely. To reduce or inhibit propagation of the crack 110, the stresses in regions of the EBC 108 adjacent to the crack 110 are reduced or reversed after the component 100 cools. To reduce the stresses adjacent to the crack 110, the EBC 108 may be heated to a temperature that causes a thermal gradient resulting from the temperature difference between the upper surface 109 of the EBC 108, the interior of the EBC 108, and the substrate 102. Over time, the thermal gradient reduces or reverses the thermal residual stresses in the EBC 108 upon cooling, and an effective stress intensity factor K_{eff} of the crack 110 is reduced. In this context, the effective stress intensity factor K_{eff} of the crack 110 is a measure of the crack driving force of the crack 110, measured in megapascals per root meter (MPa/\sqrt{m}). Reducing the effective stress intensity factor K_{eff} of the crack 110 reduces the likelihood of propagation of the crack 110 by reducing the driving force during relaxation of compressive residual stress, therefore reducing the likelihood of separation between the EBC 108 and the bond coat 106.

To provide the thermal gradient, a heater 114 provides heat to of the upper surface 109 of the EBC 108. The heater 114 may be any suitable type, such as a laser illuminator, a torch or other flame-generating device, a heating coil, an electric heater, a heat gun or other forced-air heater, or combinations thereof. The exemplary heater 114 of FIG. 1 is a laser illuminator that provides radiative heat to the EBC 108. Alternatively, the heater 114 may heat the upper surface 109 in any suitable manner, such as a single pass of laser illumination, multiple passes of laser illumination, one or more heated fluids, or combinations thereof. Additionally, specific regions of the upper surface 109 may be heated to reduce crack formation and propagation in regions prone to stresses, and specific regions of the upper surface 109 may be avoided that are less susceptible to buckling or edge-initiated spallation.

Because the heater 114 heats the upper surface 109 of the EBC 108 and not the substrate 102, the thermal gradient is formed within the EBC 108 and between the EBC and the substrate 102. The heater 114 is configured to heat the upper surface 109 of the EBC 108 to a specified temperature T_{H}. The specified temperature T_{H} may be higher than the temperature at which the component 100 underwent heat treatment. For example, when the heat treatment temperature is 2000 degrees Fahrenheit (° F.) (1100 degrees Celsius (° C.)), the specified temperature T_{H} may be 2400° F. (1300° C.).

A controller (not shown) may actuate the heater 114 for a specified period of time in order to reduce the stresses in the EBC 108. The specified period of time may be determined by empirical testing of sample components 100 at different thermal gradients held for different times, and then measuring propagation of cracks 110 between the bond coats 106 and the EBCs 108. For example, the specified period of time may be at least 1 minute, from 1 minute to 10 minutes, such as 5 minutes. When the specified period of time elapses, the controller deactivates the heater 114 to cease heating the EBC 108.

A surface temperature controller 116 may control a temperature of a lower surface 118 of the substrate 102 to a temperature that is lower than the temperature to which the heater 114 heats the EBC 108, causing the thermal gradient. Specifically, the surface temperature controller 116 may heat the lower surface 118 of the substrate 102 to a specified temperature T_{L} that is lower than the temperature at which the component 100 underwent heat treatment. For example, the specified temperature T_{L} may be 1800° F. (1000° C.). That is, the temperature difference between the upper surface 109 of the EBC 108 and the lower surface 118 of the substrate 102 in this exemplary thermal gradient is 600° F. (300° C.), and it will be appreciated that, in general, the temperature difference may be at least 400° F. (200° C.).

The heated substrate 102 may cool more slowly than exposing the substrate 102 to ambient conditions, thereby maintaining the thermal gradient within a desired range (e.g., 400-600° F.) to reduce the stresses in the EBC 108. The surface temperature controller 116 heats the substrate 102 for the specified period of time described above, such that the thermal gradient persists for the specified period of time. The surface temperature controller 116 may be any suitable type, such as a laser illuminator, a torch or other flame-generating device, a heating coil, an electric heater (such as radio-frequency, microwave, or induction heaters), a heat gun or other forced-air heater, or combinations thereof. The exemplary surface temperature controller 116 of FIG. 1 is a forced-air heater, which blows hot air past the substrate 102 to heat the substrate 102 by convection. The controller may actuate the surface temperature controller 116 for the specified period of time and, after the specified period of time has elapsed, deactivate the surface temperature controller 116 to cease heating the substrate 102.

Alternatively, the surface temperature controller 116 may have a cooling function that cools the lower surface 118 of the substrate 102. In particular, when the surface temperature controller 116 uses a forced-air heater, the surface temperature controller 116 can drive room temperature air (e.g., 72° F.) or cooled air (e.g., 40° F.) for a larger temperature difference between the upper surface 109 and the lower surface 118. The heater 114 and/or the surface temperature controller 116 may be different from a heating element for initially applying the heat treatment of the EBC.

After the elapsed period of time, the CMC component 100 undergoes a cooling process. As one example, the CMC component 100 may passively cool to ambient conditions. As another example, the CMC component 100 may be actively cooled, such as with a forced-air cooler. As yet another example, the heater 114 or the surface temperature controller 116 may heat the CMC component 100 to progressively cooler temperatures, such that the CMC component 100 cools more slowly than passive cooling.

Alternatively, after the elapsed period of time, the heater 114 and the surface temperature controller 116 may heat the EBC 108 and the substrate 102 to different temperatures according to a second temperature difference, causing a second thermal gradient. That is, the heater 114 may heat the upper surface 109 of the EBC 108 to a specified temperature below the specified temperature to which the heater 114 previously heated the upper surface 109, and the surface temperature controller 116 may heat the lower surface 118 of the substrate 102 to a specified temperature below the specified temperature to which the surface temperature controller 116 previously heated the lower surface 118. Alternatively, the upper surface 109 of the EBC 108 may be heated to the specified temperature and the temperature the lower surface 118 of the substrate 102 may not be controlled at all to form the second thermal gradient. At these lower temperatures of the second thermal gradient, the thermal stresses in the EBC 108 may be further controlled.

The heater 114 and the surface temperature controller 116 may maintain the second thermal gradient for a second specified period of time. It will be appreciated that the second temperature difference may be the same as the temperature difference (600° F. in this example), or the second temperature difference may be different than the temperature difference. The second specified period of time may be the same as the specified period of time (5 minutes in this example), or the second specified period of time may be different than the specified period of time. In such a form, portions of the CMC component 100 may be heated to several different temperatures prior to completely cooling, including a first temperature at which the upper surface 109 is heated to form the first thermal gradient, a second temperature at which the lower surface 118 is controlled to form the first thermal gradient, a third temperature at which the upper surface 109 is heated to form the second thermal gradient, and a fourth temperature at which the lower surface 118 is controlled to form the second thermal gradient. It will be appreciated that the CMC component 100 may be heated to form additional thermal gradients before completely cooling.

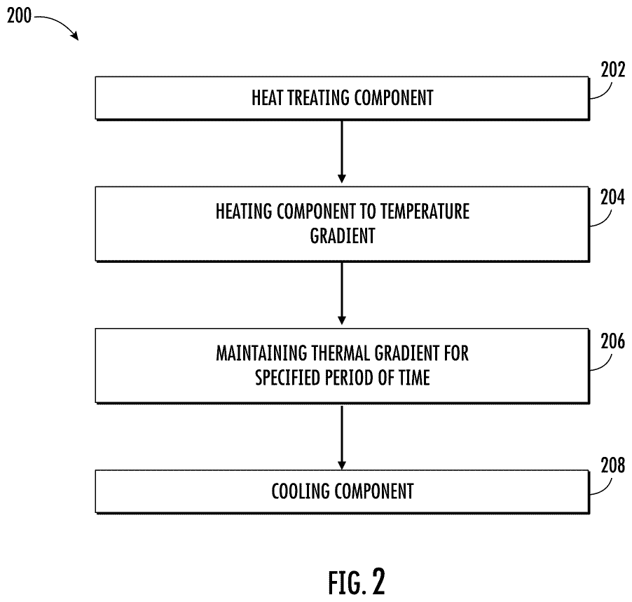

Referring now to FIG. 2, a flow diagram of a method 200 of processing a CMC component in accordance with an exemplary aspect of the present disclosure is provided. The method 200 of FIG. 2 may be utilized to process one or more of the exemplary CMC components 100 described above with reference to FIG. 1.

As is depicted, the method 200 includes at (202) heat treating a CMC component. Heat treatment at the first temperature allows parts of the CMC component to form and cure. The temperature to which the CMC component is heated is determined to facilitate the heat treatment. As one example, the temperature may be 2000° F. (1100° C.).

The method 200 includes at (204), after heat treating the CMC component, heating an upper surface of an EBC of the CMC component and controlling a temperature of a lower surface of a substrate of the CMC component such that the upper surface and the lower surface have a specified temperature difference. As described above, a heater and a temperature controller can provide heat at specific temperatures to the upper surface and the lower surface, causing the temperature difference. The temperature difference may be in a range from 400-600° F. Upon completion of the heat treatment at (202), a crack may form between the EBC and a bond coat of the CMC component under operation. Thermal stresses in the EBC may cause the crack to propagate, separating the EBC from the bond coat. To reduce the thermal stresses, the upper surface of the EBC is heated to a temperature greater than the lower surface of the substrate of the CMC component. That is, at least the EBC is heated following the heat treatment to cause a thermal gradient between the EBC and the substrate, which reduces thermal stresses in the EBC after cooling. The entire upper surface of the EBC may be heated to provide the thermal gradient, reducing stresses throughout the EBC after cooling. Alternatively, select portions of the upper surface of the EBC may be heated, focused on specific regions of the CMC component where cracks may preferentially form, such as near edges and away from pressure side regions.

The method 200 includes at (206) maintaining the thermal gradient for a specified period of time. Maintaining the thermal gradient over a period of time reduces or reverses stresses in the EBC upon cooling, which reduces crack propagation between the EBC and the bond coat. Specifically, an effective stress intensity factor of the crack reduces as a result of the reduction in thermal stresses, which reduces the likelihood that the crack would propagate. The specified period of time may be determined with empirical testing, as described above.

The method 200 includes at (208), after the specified period of time has elapsed, ceasing heating of the EBC and the substrate and cooling the CMC component. Once the specified period of time has elapsed, the effective stress intensity factor is reduced such that crack propagation is reduced, and the likelihood of separation between the EBC and the bond coat is reduced. The CMC component may then undergo a conventional cooling process, such as passively cooling to ambient conditions. Alternatively, the method 200 may return to (204) to heat the CMC component to different temperature gradients for specified periods of time, further controlling stresses to reduce crack formation and propagation. That is, the CMC component may undergo a second thermal gradient, a third thermal gradient, or any number of thermal gradients until cooled completely.

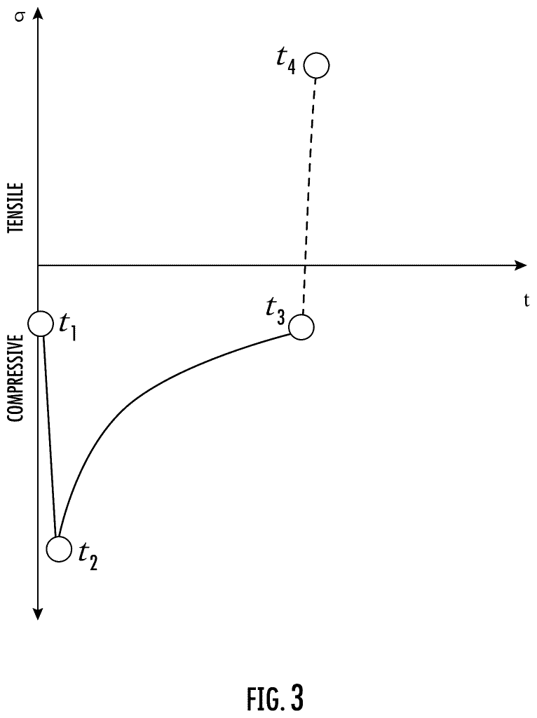

Now referring to FIG. 3, a diagram of exemplary stresses at the top surface of the EBC is shown. The vertical axis shows the stresses σ, and the horizontal axis shows time. The portion of the vertical axis above the horizontal axis represents tensile stresses, and the portion of the vertical axis below the horizontal axis represents compressive stresses.

At a time t₁, the CMC component is about to undergo a heat treatment. At this time, stresses in the CMC component are compressive, and crack formation between the EBC and the bond coat is low, if occurring at all.

At a time t₂, the CMC component finishes the heat treatment. The stresses in the CMC component are compressive and higher than those at the time t₁. If left to cool passively, the change in the stresses may cause edge cracks between the bond coat and the EBC to form and propagate, leading to spallation. To reduce or inhibit the crack formation and propagation, the EBC is heated and the substrate is heated or cooled to cause a temperature gradient in the EBC.

At a time t₃, the CMC component has been held at the temperature gradient, reducing stresses at the EBC surface. The stresses are still compressive stresses after cooling, but the stresses are lower than those at the time t₂.

At a time t₄, the CMC component cools passively to ambient room temperature. During cooling, the stresses transition from compressive stresses towards tensile stresses. Because the CMC component was held at the temperature gradient, the reduction in compressive stresses reduce interfacial edge crack formation and propagation. The overall durability of the CMC component is thus improved.

Further aspects are provided by the subject matter of the following clauses:

A method for processing a ceramic matrix composite (CMC) component with an environmental barrier coating (EBC) includes heat treating the CMC component, after heat treating the CMC component, heating an upper surface of the EBC of the CMC component to a first temperature and controlling a temperature of a lower surface of a substrate of the CMC component at a second temperature that is less than the first temperature to maintain a thermal gradient within the EBC within a specified range for a specified period of time, and after the specified period of time has elapsed, ceasing heating of the upper surface of the EBC and controlling of the temperature of the lower surface of the substrate.

The method of any of the preceding clauses, wherein the upper surface of the EBC is heated with a heater and the temperature of the lower surface of the substrate is controlled with a surface temperature controller.

The method of any of the preceding clauses, wherein the heater includes at least one of a laser, a torch, or a forced-air heater.

The method of any of the preceding clauses, wherein the surface temperature controller includes at least one of a laser, a torch, a forced-air heater, or a forced-air cooler.

The method of any of the preceding clauses, further including, after ceasing heating of the upper surface of the EBC, heating the upper surface of the EBC to a third temperature and controlling the temperature of the lower surface of the substrate to a fourth temperature for a second specified period of time, wherein the third temperature is greater than the fourth temperature.

The method of any of the preceding clauses, wherein the specified range of the thermal gradient and the specified period of time reduces an effective stress intensity factor of a crack between the EBC and a bond coat on which the EBC is disposed.

The method of any of the preceding clauses, wherein the first temperature and the second temperature are determined based on a specified temperature difference.

The method of any of the preceding clauses, wherein the specified temperature difference is at least 400 degrees Fahrenheit.

The method of any of the preceding clauses, wherein the specified period of time is determined to reduce an effective stress intensity factor of a crack between the EBC and a bond coat on which the EBC is disposed.

The method of any of the preceding clauses, further including, after ceasing heating of the upper surface of the EBC and the substrate, heating the upper surface of the EBC to a third temperature without controlling the temperature the lower surface of the substrate.

The method of any of the preceding clauses, wherein the first temperature is greater than 2000 degrees Fahrenheit, and the second temperature is below 2000 degrees Fahrenheit.

The method of any of the preceding clauses, wherein the first temperature is in a range from 2200 to 2600 degrees Fahrenheit.

The method of any of the preceding clauses, wherein the second temperature is in a range from 1500 to 1900 degrees Fahrenheit.

The method of any of the preceding clauses, further including, after ceasing heating of the upper surface of the EBC and the lower surface of the substrate, allowing the CMC component to cool passively.

The method of any of the preceding clauses, further including, after ceasing heating of the upper surface of the EBC and the lower surface of the substrate, actively cooling the CMC component.

The method of any of the preceding clauses, wherein the EBC includes a rare earth silicate.

The method of any of the preceding clauses, wherein the CMC component further includes a silicon-based bond coat bonding the EBC to the substrate.

The method of any of the preceding clauses, wherein the CMC component includes an edge and a crack is disposed in the edge, wherein the method further includes reducing compressive stress adjacent to the crack.

The method of any of the preceding clauses, wherein the crack is disposed between the EBC and a bond coat, wherein the method further comprises reducing compressive stress in the EBC.

A CMC component formed according to the method of any of the preceding clauses.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for processing a ceramic matrix composite (CMC) component with an environmental barrier coating (EBC), the method comprising:
heat treating the CMC component;
after heat treating the CMC component, heating an upper surface of the EBC of the CMC component to a first temperature and controlling a temperature of a lower surface of a substrate of the CMC component at a second temperature that is less than the first temperature to maintain a thermal gradient within the EBC within a specified range for a specified period of time; and
after the specified period of time has elapsed, ceasing heating of the upper surface of the EBC and controlling of the temperature of the lower surface of the substrate.

2. The method of claim 1, wherein the upper surface of the EBC is heated with a heater and the temperature of the lower surface of the substrate is controlled with a surface temperature controller.

3. The method of claim 2, wherein the heater includes at least one of a laser, a torch, or a forced-air heater.

4. The method of claim 2, wherein the surface temperature controller includes at least one of a laser, a torch, a forced-air heater, or a forced-air cooler.

5. The method of claim 1, further comprising, after ceasing heating of the upper surface of the EBC, heating the upper surface of the EBC to a third temperature and controlling the temperature of the lower surface of the substrate to a fourth temperature for a second specified period of time, wherein the third temperature is greater than the fourth temperature.

6. The method of claim 1, wherein the specified range of the thermal gradient and the specified period of time reduces an effective stress intensity factor of a crack between the EBC and a bond coat on which the EBC is disposed.

7. The method of claim 1, wherein the first temperature and the second temperature are determined based on a specified temperature difference.

8. The method of claim 7, wherein the specified temperature difference is at least 400 degrees Fahrenheit.

9. The method of claim 1, wherein the specified period of time is determined to reduce an effective stress intensity factor of a crack between the EBC and a bond coat on which the EBC is disposed.

10. The method of claim 1, further comprising, after ceasing heating of the upper surface of the EBC and the substrate, heating the upper surface of the EBC to a third temperature without controlling the temperature the lower surface of the substrate.

11. The method of claim 1, wherein the first temperature is greater than 2000 degrees Fahrenheit, and the second temperature is below 2000 degrees Fahrenheit.

12. The method of claim 11, wherein the first temperature is in a range from 2200 to 2600 degrees Fahrenheit.

13. The method of claim 11, wherein the second temperature is in a range from 1500 to 1900 degrees Fahrenheit.

14. The method of claim 1, further comprising, after ceasing heating of the upper surface of the EBC, allowing the CMC component to cool passively.

15. The method of claim 1, further comprising, after ceasing heating of the upper surface of the EBC, actively cooling the CMC component.

16. The method of claim 1, wherein the EBC includes a rare earth silicate.

17. The method of claim 1, wherein the CMC component further includes a silicon-based bond coat bonding the EBC to the substrate.

18. The method of claim 1, wherein the CMC component includes an edge and a crack is disposed in the edge, wherein the method further comprises reducing compressive stress adjacent to the crack.

19. The method of claim 18, wherein the crack is disposed between the EBC and a bond coat, wherein the method further comprises reducing compressive stress in the EBC.

20. A CMC component formed according to the method of claim 1.
